(19) United States
(12) Patent Application Publication
(10) Pub. No.: US 2009/0242443 A1
(43) Pub. Date: Oct. 1, 2009

(54) TOOL STORAGE ASSEMBLY

(76) Inventor: Chang-Ying CHEN, Taichung (TW)

Correspondence Address: Chien-Hui Su, P. O. Box 70-121 Taichung, Taichung City, 40899, TW

(21) Appl. No.: 12/056,282

(22) Filed: Mar. 27, 2008

(51) Int. Cl. B65D 85/20; B25H 3/00

(52) U.S. Cl. 206/375

(57) ABSTRACT

A tool storage assembly includes a body; the body has a main supporting unit and a plurality of sub-supporting units which are installed to the main supporting unit; wherein the main supporting unit has a receiving portion for receiving an object; and the main supporting unit having a plurality of positioning grooves the number of which is corresponding to that of the sub-supporting units for positioning; each sub-supporting unit having a receiving groove for receiving an object; each sub-supporting unit having a pivotal portion and a position unit; the pivotal portion serving to position the sub-supporting unit to the main supporting unit so that the sub-supporting unit is pivoted to the main supporting unit with a predetermined moving angle therebetween; the position unit can be inserted into the positioning groove so that the sub-supporting unit can be closed to the main supporting unit.

### FIELD OF THE INVENTION

The present invention relates to tool packages, and particularly to a tool storage assembly which has a reduced storage space for arranging, retaining and receiving a holding unit and a plurality of driving units so that the tools can be stored or ordered effectively and conveniently.

### BACKGROUND OF THE INVENTION

With the current trend of DIY (do it yourself), the hand tools become necessary devices in home, office or working places. The tool assembly has a trend of combining many tools in one packet so as to suit various conditions for working and assembling. One example of such case is that a holding unit is used to suit many different driving units so that only one holding unit is prepared.

Current commercial compound tool package has one receiving box for receiving a holding unit and a plurality of driving units, such as U.S. Pat. No. 6547074 which is assigned to the inventor of the present invention with a title of: Tool box having pivotal inner frames, in that a box has bottom. A clamping portion is installed on the bottom. A cover of the box is installed with two receiving portions which are interacted with the cover. The clamping portion serves for placing the holding unit of a hand tool. A receiving portion serves for receiving the driving units of hand tools. When the cover is opened, the two receiving portions will interact so that the heads of the driving units move upwards. The holding unit is taken out from the clamping portion and the driving unit is taken out from the receiving portion and then is inserted into the holding unit so that a hand tool is got for working.

However in the box, the holding unit is placed transversally and the driving units are arranged linearly so that the space is not used effectively. Many spaces are surplus. Furthermore, the box must have a great structure for receiving the holding unit transversally and arranging the driving units linearly. Thus, in storage, a larger space is needed for storage.

Besides, in taking a tool, the box must be opened firstly, and then a distal end of the driving unit is aligned to the holding unit for working. In replacing a driving unit, a head of a driving unit is taken out and then its direction is changed for being placed into the receiving portion. The operation is repeated for taking another one for engaging with the holding unit and for other works. Thus, the box has the effect of storing hand tools, but the operation of taking a tool or updating a new tool is tedious and time consumed.

### SUMMARY OF THE INVENTION

The present invention provides a tool storage assembly for improving the defects in the prior art, while the present invention uses less space and the tool can be taken out or replaced with a new one with an easy operation.

To achieve above object, the present invention provides a tool storage assembly comprising a body; the body having a main supporting unit and a plurality of sub-supporting units which are installed to the main supporting unit; the sub-supporting units are arranged around the main supporting unit coaxially so that an axial direction of an arranged of all the sub-supporting units are parallel to the axial direction of the main supporting unit.

The main supporting unit has a receiving portion for receiving an object, and a plurality of positioning grooves the number of which is corresponding to that of the sub-supporting units. The main supporting unit is formed with a plurality of protrusions and a plurality of spacing walls which are alternatively arranged. Each protrusion is formed with a connecting hole for receiving the pivotal portion; and each spacing wall is formed with a positioning groove. A lower side of the main supporting unit has a base for enlarging the contact area at a lower side of the main supporting unit so that the main supporting unit can be steadily located along the axial direction.

Each sub-supporting unit has a receiving groove for receiving a driving unit; the specification of the driving unit is indicated on the sub-supporting unit. Each sub-supporting unit has a pivotal portion and a position unit. Each of the pivotal portions of the sub-supporting unit has a projection for installing the sub-supporting unit to the main supporting unit and as an axial center in rotation. The pivotal portion of the sub-supporting unit is formed with a retaining surface which can resist against the main supporting unit so that the sub-supporting unit rotates with a limited angle range. The pivotal portion serves to position the sub-supporting unit to the main supporting unit so that the sub-supporting unit is pivoted to the main supporting unit with a predetermined moving angle therebetween. The position unit can be inserted into the positioning groove so that the sub-supporting unit can be closed to the main supporting unit. Each position unit has a stem for enhancing the positioning of the position unit.

By above structure, the holding unit and driving units can be arranged coaxially and tightly to reduce the required space between the main supporting unit and the sub-supporting units so as to have the effect of storage, ordering and reduction of storing space. The sub-supporting units can rotate outwards from the main supporting unit. In use of a tool, the holding unit is taken out and the user views the specifications on the sub-supporting units so as to select a desired one. In update a new one, the original used tool is placed into the original position and the holding unit is engaged to another tool to be used. The operation is very convenient.

Thus, in practice, the present invention indeed improve the defects in the prior art and provides some novel usages to the users.

The various objects and advantages of the present invention will be more readily understood from the following detailed description when read in conjunction with the appended drawing.

### BRIEF DESCRIPTION OF THE DRAWINGS

FIG. 1 is an exploded perspective view of the tool order structure of the present invention.

FIG. 2 is a schematic perspective view showing that after assembly, all the sub-supporting units are at a storage state according to the present invention.

FIG. 3 is a schematic view showing all the sub-supporting units are expanded according to the present invention.

FIG. 4 is a schematic view showing the top structure of the present invention.

FIG. 5 is a schematic view showing a cross sectional view and a perspective view along line AB of FIG. 4.

FIG. 6 is a cross sectional view showing an expanding state of the structure illustrated in FIG. 5.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

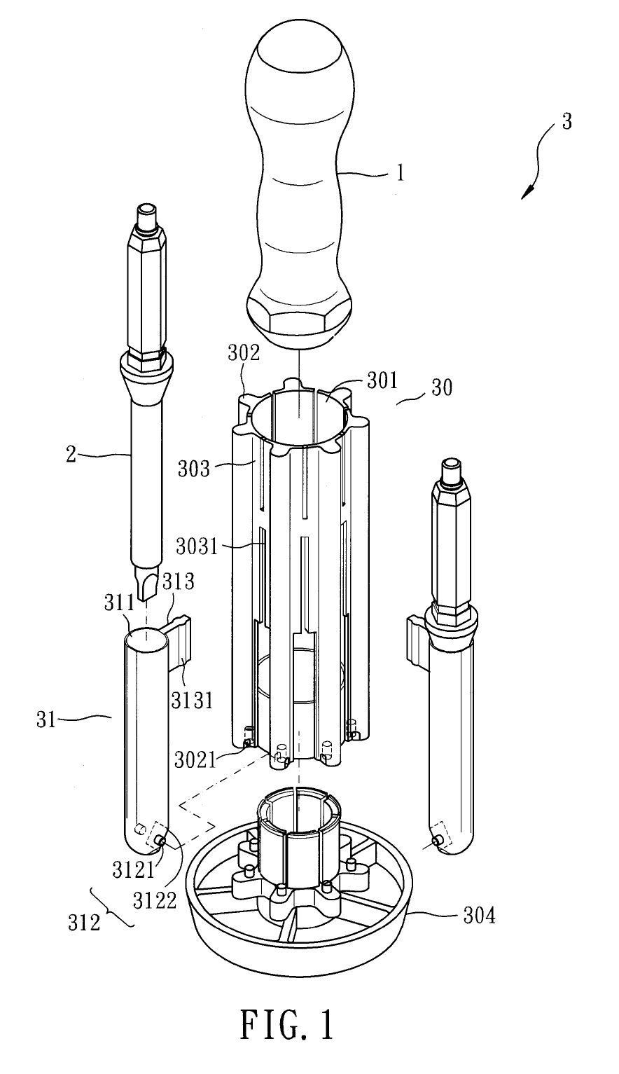

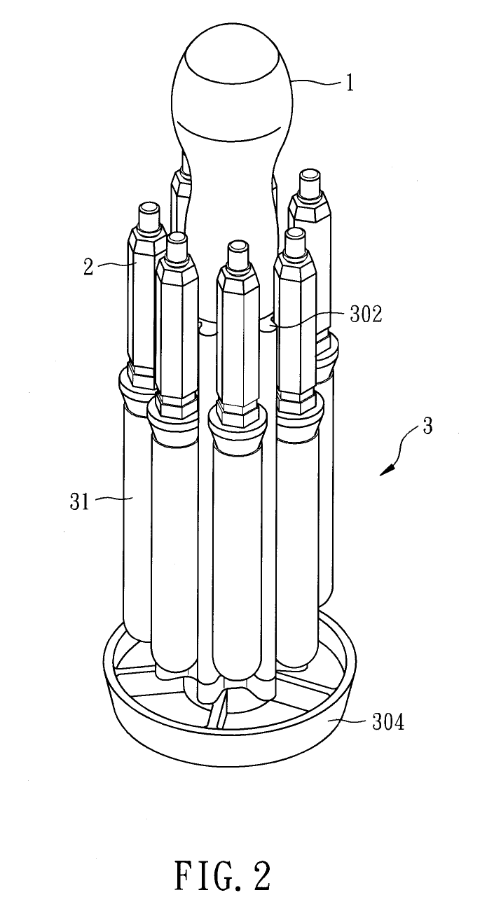

Referring to FIGS. 1 and 2 the replaceable screw opener according to the present invention is illustrated. The screw driver 3 of the present invention has a holding unit 1 and a plurality of driving units 2.

The screw driver 3 further has a main supporting unit 30 and a plurality of sub-supporting units 31. In this embodiment, the main supporting unit 30 and the sub-supporting units 31 have cylindrical shapes. The sub-supporting units 31 are arranged around the main supporting unit 30 annularly so that the axial line of the arrangement of the plurality of sub-supporting units 31 is parallel to the axial line of the main supporting unit 30.

The main supporting unit 30 is a receiving portion 301 at an axial direction thereof. The receiving portion 301 serves to receive the holding unit 1 by inserting into the opening of the receiving portion 301. An outer periphery of the main supporting unit 30 is protruded with a plurality of protrusions 302 and a plurality of spacing walls 303 each between two spacing walls 303. A lower end of each protrusion 302 has a connecting hole 3021. Each spacing wall 303 has a positioning groove 3031 extending from a lower edge thereof for positioning a respective sub-supporting unit 31.

Each sub-supporting unit 31 is axially formed with a receiving groove 311 for receiving a head end of a respective driving unit 2. The sub-supporting unit 31 is indicated with a specification of the driving unit 2 inserted therein, such as sizes, type numbers, classes, etc. Besides, the sub-supporting unit 31 is installed with a projection 3121 and a retaining surface 3122. The projection 3121 is assembled to the connecting hole 3021 of the protrusion 302. The projection 3121 is assembled to the connecting hole 3021 of the protrusion 302. The inclined surface of the retaining surface 3122 resists against the main supporting unit 30 so that the sub-supporting unit 31 is rotatable along the projection 3121 and from the main supporting unit 30 to the outer side of the main supporting unit 30. An upper side of the sub-supporting unit 31 is protruded with a position unit 313. The position unit 313 is formed with a stem 3131. The position unit 313 can be inserted into the positioning groove 3031 in the spacing wall 303 of the main supporting unit 30. The stem 3131 serves to retain the position unit 313 in the spacing wall 303 so that the sub-supporting unit 31 can be positioned to the main supporting unit 30.

Finally, a lower side of the main supporting unit 30 has a base 304 for enlarging the contact area at a lower side of the main supporting unit 30 so that the main supporting unit 30 can be steadily located along the axial direction. When the sub-supporting unit 31 rotates outwards from the main supporting unit 30 through a predetermined angle, the retaining surface 3122 resists against a wall of the base 304.

Thereby in the present invention, the main supporting unit 30 receives the holding unit 1 and the sub-supporting units 31 receive the driving units 2 based on the indications thereon. The holding unit 1 and the driving units 2 are located coaxially and tightly so as to reduce the space between the main supporting unit 30 and the sub-supporting units 31 to have the effect of storage and ordering.

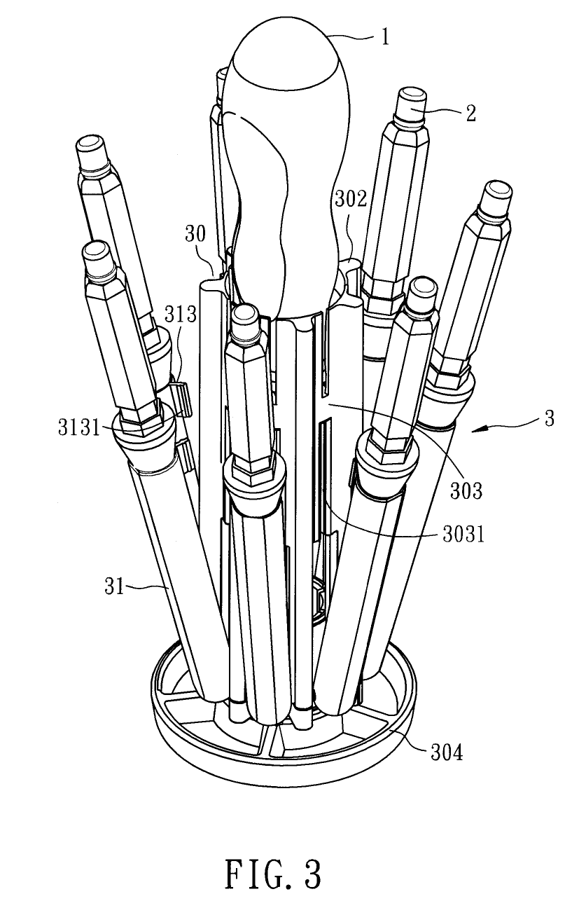

With referring to FIG. 3, when the sub-supporting units 31 rotate outwards from the main supporting unit 30, the overall structure is like an umbrella. The alternation arrangement of the protrusions 302 and the spacing walls 303, the driving units 2 inserted into the sub-supporting units 31 are spaced. Thus, in use, it is only necessary to take the holding unit 1 out of the main supporting unit 30, the indications on the sub-supporting units 31 can be viewed for getting a desired driving unit 2. If it is desired to get another driving unit 2, the original used driving unit 2 is inserted into the sub-supporting unit 31, and the holding unit 1 is engaged to another driving unit 2. Thus the taking and replacement of the driving units 2 according to the present invention can be performed easily and conveniently.

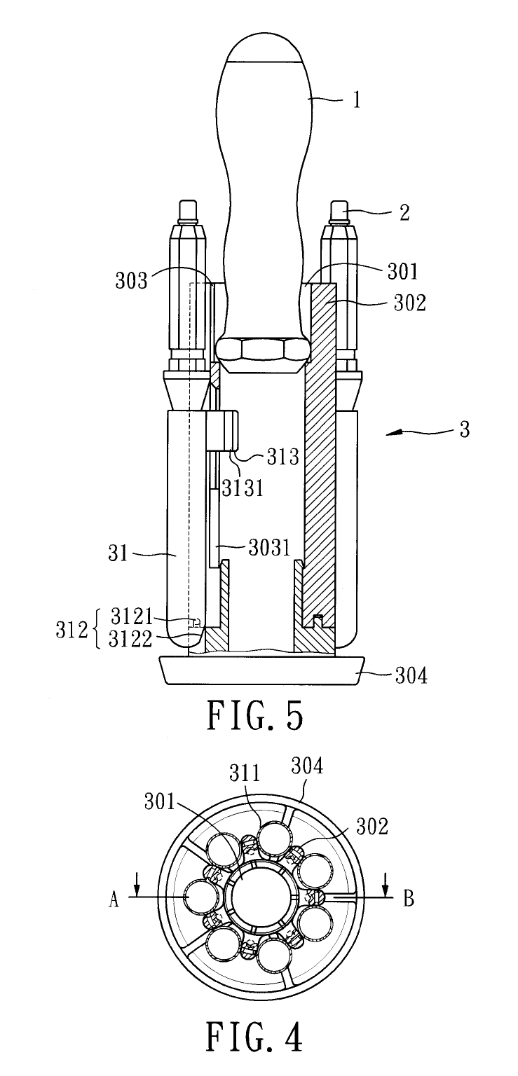

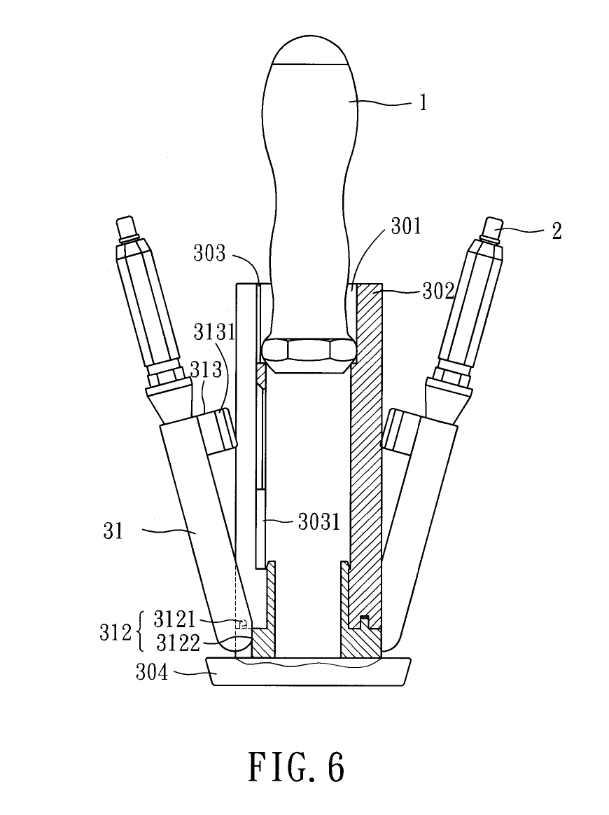

With referring to FIG. 4 to 6, see FIG. 4, in the present invention, the sub-supporting units 31 are arranged around the main supporting unit 30 coaxially as a ring. Thus the main supporting unit 30 can be arranged axially and uprightly. After use, the sub-supporting units 31 are moved to be near the main supporting unit 30. The position unit 313 is inserted into the positioning groove 3031 so that the sub-supporting unit 31 is retained to the main supporting unit 30. Thus the storage space of the body 3 is reduced. Referring to FIG. 5, when the sub-supporting units 31 are moved near the main supporting unit 30, only one edge of the retaining surface 3122 resists against the base 304 so as not to hinder the storage action of the sub-supporting units 31. As shown in FIG. 6, when the sub-supporting units 31 move outwards, the retaining surface 3122 will resist against the base 304 so that the sub-supporting units 3 1 are retained to a predetermined angle from the main supporting unit 30 without over-extending so that the sub-supporting units 31 are arranged as an umbrella.

Therefore, in the present invention, by the active structure of the main supporting unit 30 and the sub-supporting units 31, the storage space is effective and the order of the tools is also effective. The operations of taking a driving unit 2 or replacing with another one are easy and convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tool storage assembly comprising a body; the body having a main supporting unit and a plurality of sub-supporting units which are installed to the main supporting unit; wherein
the main supporting unit has a receiving portion for receiving an object;
and the main supporting unit having a plurality of positioning grooves the number of which is corresponding to that of the sub-supporting units for positioning;
each sub-supporting unit having a receiving groove for receiving an object; each sub-supporting unit having a pivotal portion and a position unit; the pivotal portion serving to position the sub-supporting unit to the main supporting unit so that the sub-supporting unit is pivoted to the main supporting unit with a predetermined moving angle therebetween; the position unit can be inserted into the positioning groove so that the sub-supporting unit can be closed to the main supporting unit;
wherein by above mentioned components, the body serves to receive at least one tools with a small space and the tool can be taken out easily and conveniently.

2. The tool storage assembly as claimed in claim 1, wherein the pivotal portion of the sub-supporting unit is formed with a retaining surface which can resist against the main supporting unit so that the sub-supporting unit rotates with a limited angle range.

3. The tool storage assembly as claimed in claim 2, wherein the retaining surface is an inclined surface so that the sub-supporting unit can rotate outwards from the main supporting unit to a limit angle range, when the sub-supporting unit is closed upon the main supporting unit, one end of the retaining surface resists against the main supporting unit.

4. The tool storage assembly as claimed in claim 1, wherein the main supporting unit is formed with a plurality of protrusions and a plurality of spacing walls which are alternatively arranged; each protrusion is formed with a connecting hole for receiving the pivotal portion; and each spacing wall is formed with a positioning groove; each of the pivotal portion of the sub-supporting unit has a projection for installing the sub-supporting unit to the main supporting unit and as an axial center in rotation.

5. The tool storage assembly as claimed in claim 1, wherein the main supporting unit is installed with a base for stabilizing the main supporting unit uprightly and for resisting against the pivotal portion.

6. The tool storage assembly as claimed in claim 1, wherein the sub-supporting units are arranged around the main supporting unit coaxially so that an axial direction of an arranged of all the sub-supporting units are parallel to the axial direction of the main supporting unit.

7. The tool storage assembly as claimed in claim 1, wherein the receiving portion of the main supporting unit serves for receiving a holding unit of a tool and the receiving groove of the sub-supporting unit serves for receiving a driving unit; a specification of the driving unit is indicated upon the sub-supporting unit.

8. The tool storage assembly as claimed in claim 1, wherein each position unit has a stem for enhancing the positioning of the position unit.
